(19) United States
(12) Patent Application Publication
(10) Pub. No.: US 2009/0318136 A1
(43) Pub. Date: Dec. 24, 2009

(54) Method for Operation of a Mobile Communication System, and Corresponding Mobile Communication System

(76) Inventors: Markus Dillinger, Oberhaching (DE); Jijun Luo, Munchen (DE); Jianming Pan, Wien (AT); Egon Schulz, Munchen (DE); Peter Slanina, Judenau (AT)

Correspondence Address: STAAS & HALSEY LLP, SUITE 700, 1201 NEW YORK AVENUE, N.W., WASHINGTON, DC, 20005, US

(21) Appl. No.: 12/223,522

(22) PCT Filed: Dec. 6, 2006
(86) PCT No.: PCT/EP2006/069391

§ 371 Date: Dec. 22, 2008

(30) Foreign Application Priority Data
Feb. 2, 2006 (EP) 06002167.2

(51) Int. Cl. H04W 92/00

(52) U.S. Cl. 455/426.1

(57) ABSTRACT

A first network radio station communicates with a user station with the aid of first radio technology while a second network radio station simultaneously communicates using second radio technology, receives data on radio technologies that can be utilized by the user station, and performs a reconfiguration process allowing the second network radio station to utilize the first radio technology. The second network radio station then communicates with the user station with the aid of the first radio technology.

### CROSS REFERENCE TO RELATED APPLICATIONS

This application is based on and hereby claims priority to European Application No. 06002167 filed on Feb. 2, 2006, the contents of which are hereby incorporated by reference.

### BACKGROUND

Described below is a method for operating a mobile radio communication system, in which a first network radio station communicates with a subscriber station using a first radio technology, while at the same time a second network radio station communicates using a second radio technology.

In radio communication systems, messages, for example containing voice information, image information, video information, SMS (Short Message Service), MMS (Multimedia Messaging Service) or other data, are transmitted between a sending and a receiving station via a radio interface using electromagnetic waves. Depending on the specific embodiment of the radio communication system, the stations in this case may be different types of subscriber stations or network radio stations, such as repeaters, radio access points or base stations. In a mobile radio communication system, at least some of the subscriber stations are mobile radio stations. The electromagnetic waves are emitted at carrier frequencies which are situated in the frequency band which is provided for the respective system.

Mobile radio communication systems are often in the form of cellular systems, e.g. based on the GSM (Global System for Mobile Communication) or UMTS (Universal Mobile Telecommunications System) standard, with a network infrastructure including base stations, devices for inspecting and controlling the base stations and other network devices, for example. Apart from these cellular, hierarchic radio networks organized over a wide space (supralocal), there are also wireless local area networks (WLANs) having a radio coverage area which is usually much more limited in terms of space. Examples of different standards for WLANs are HiperLAN, DECT, IEEE 802.11, Bluetooth and WATM.

On the basis of technological development, there are simultaneously subscriber stations which use one particular radio technology and subscriber stations which use another radio technology. Examples which may be mentioned are the change from GSM to UMTS or that from 3G to 3G LTE (Long Term Evolution) systems.

Described below is a method for operating a mobile radio communication system and a mobile radio communication system which take account of the fact that different subscriber stations use different radio technologies.

### SUMMARY

In the method for operating a mobile radio communication system described below, a first network radio station communicates with a subscriber station using a first radio technology. At the same time, a second network radio station communicates using a second radio technology, receives information about radio technologies which can be used by the subscriber station, and performs a reconfiguration which allows it to use the first radio technology. Subsequently, the second network radio station communicates with the subscriber station using the first radio technology.

At the beginning of the method, the subscriber station communicates with the first network radio station, employing the first radio technology to do so. At this time, the second network radio station uses the second radio technology and not the first radio technology for communication. It receives information about one or more radio technologies which the subscriber station can use, particularly about the fact that the subscriber station can use the first radio technology. This information can be sent to the second network radio station from the first network radio station, or alternatively from another device.

In response to receipt of the information, the second network radio station is reconfigured. This allows the second network radio station to use the first radio technology. This means that the second network radio station cannot use the first radio technology before the reconfiguration. The second network radio station's use of the first radio technology, which takes place after the reconfiguration, can take place in addition to or instead of the use of the first radio technology. The second network radio station's communication with the subscriber station preferably takes place directly after the first network radio station's communication with the subscriber station, that is to say after handover from the first to the second network radio station.

In one development, the reconfiguration includes one or more of the following operations:

Downloading a piece of software which is required for use of the first radio technology. This is particularly relevant if the second network radio station has not yet used the first radio technology before or if, although it has used it, it has erased the software which is required for this.

Activating a piece of software which is required for use of the first radio technology. This is particularly relevant if, although the second network radio station has stored the software, the software is not in a ready-to-use state.

Obtaining authorization to use the first radio technology. This may involve a license for using a piece of software, for example. In addition, agreement with other network radio stations or a central device is possible, so that interference which can be caused by the use of the first radio technology by the second network radio station is avoided.

Reserving radio resources which can be employed for the use of the first radio technology. The reservation can be made vis-à-vis other network radio stations, or else within the radio cell of the second network radio station. The latter can be accomplished by reallocating radio resources which are already allocated to subscriber stations.

In line with one refinement, the first and second radio technologies are based on different frequency ranges of the same radio standard, or on different radio standards. In both cases, the difference between the radio technologies is such that a reconfiguration is necessary before the first radio technology is to be used if at present the second radio technology is being used.

In one development, the second network radio station is selected from a plurality of network radio stations using information relating to one or more of the following variables:

A location of the subscriber station. The location can be determined using inherently known measures for location.

The movement of the subscriber station. This variable is determined preferably using a plurality of locations. If the subscriber station is moving towards a radio cell of a network radio station, this network radio station is preferably selected as the second network radio station.

Traffic routes in the radio coverage area of the first network radio station. This may be an indication of the network radio station towards which the subscriber station is moving.

Information about radio technologies which can be used by the subscriber station. By way of example, this means that it is possible to try to select a network radio station for which a reconfiguration is possible, in principle, as the second network radio station.

The usability of the first radio technology by the second network radio station. If a reconfiguration for a network radio station would be possible only with a high level of complexity, selection of the relevant network radio station as the second network radio station should be avoided.

The current utilization level of the second network radio station. This allows what is known as “load balancing” to be implemented, for equalization of load between different network radio stations.

The second network radio station is preferably selected by the first network radio station, the latter having the respective information based on the aforementioned criteria available for this purpose. Alternatively, the selection can also be made by a central device, if appropriate with the cooperation of the first network radio station.

In one refinement, the reconfiguration takes place before handover of the subscriber station from the first network radio station to the second network radio station begins. The beginning of handover to the second network radio station is distinguished by the second network radio station being informed that the subscriber station will change to its radio cell.

Preferably, the second network radio station, during communication with the subscriber station using the first radio technology, communicates with at least one further subscriber station using the second radio technology. This means that the second network radio station does not end use of the second radio technology after the reconfiguration has been performed, but rather continues it, even if the first radio technology is being used.

In one refinement, before the second network radio station receives the information about radio technologies which can be used by the subscriber station, the subscriber station sends this information to the first network radio station. In this case, it is possible for the information which the second network radio station receives to be only a subset of the information which the subscriber station sends the first network radio station about radio technologies which can be used by the subscriber station.

In line with one development, the second network radio station sends information about the reconfiguration. The content of this information is preferably that the reconfiguration has taken place. In addition or alternatively, it may indicate progress by the second network radio station in performing the reconfiguration. The information can be sent to the first network radio station, directly or by a device which forwards the information. Alternatively, the information can also be sent to another device. The information should be sent, at least inter alia, to that device which decides about handover of the subscriber station.

It is advantageous if the first network radio station sends the subscriber station a message prohibiting the change of radio technology. This makes it possible to prevent the subscriber station from changing from the first radio technology to another radio technology after the second network radio station has performed the reconfiguration specifically for the subscriber station.

In one refinement, information about radio technologies which can be used by the subscriber station is received by a plurality of network radio stations, which then perform a reconfiguration which allows use of the first radio technology. This means that a plurality of network radio stations are available as handover candidates for the subscriber station, and the subscriber station could use the first radio technology for any of the handover candidates.

The mobile radio communication system may include at least one subscriber station, and also a first and a second network radio station. The first network radio station communicates with the subscriber station using a first radio technology. The second network radio station communicates using a second radio technology at the same time as the first network radio station is communicating with the subscriber station using the first radio technology. The mobile radio communication system sends information about radio technologies which can be used by the subscriber station to the second network radio station at the same time as the first network radio station is communicating with the subscriber station using the first radio technology. The second network radio station performs a reconfiguration, which allows it to use the first radio technology, at the same time as the first network radio station is communicating with the subscriber station using the first radio technology. In addition, the second network radio station communicates with the subscriber station using the first radio technology following reconfiguration.

The mobile radio communication system accordingly is particularly suitable for carrying out the method described below, and this can also apply to the refinements and developments.

### BRIEF DESCRIPTION OF THE DRAWINGS

These and other aspects and advantages will become more apparent and more readily appreciated from the following description of an exemplary embodiment, taken in conjunction with the accompanying drawings of which:

FIG. 1 is a block diagram of a portion of a mobile radio communication system.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

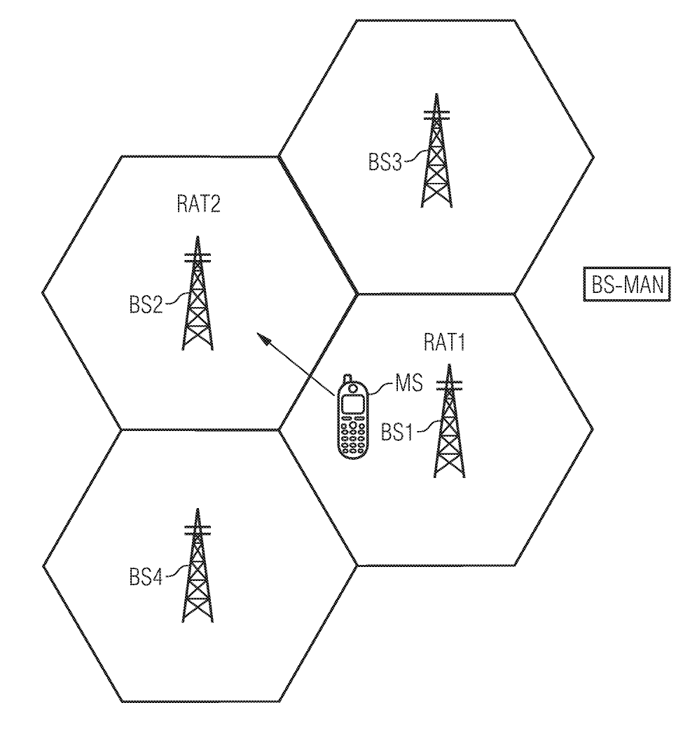

The detail from a mobile radio communication system which is shown in FIG. 1 includes the base stations BS1, BS2, BS3 and BS4. The system under consideration may be a mobile radio communication system based on the UMTS standard, for example. Each of the base stations BS1, BS2, BS3 and BS4 can communicate with subscriber stations in its radio cell, respectively symbolized by a hexagon for simplicity. One such subscriber station, the mobile station MS, is currently communicating with the base station BS1. In addition, the device BS-MAN is part of the mobile radio communication system and is connected to the base stations BS1, BS2, BS3 and BS4—not shown in FIG. 1 for the sake of clarity. The device BS-MAN can receive information from the base stations BS1, BS2, BS3 and BS4 and/or can send it to them and can also forward information which is to be transmitted from base station to base station.

In the course of or at the beginning of the communication between the mobile station MS and the base station BS1, the mobile station MS notifies the base station BS1 about its capabilities and/or requirements in respect of radio technologies. This may involve the mobile station MS indicating, by way of example, that it can only communicate using one particular radio technology, or that it is proficient in a plurality of radio technologies, but possibly prefers a particular one. The communication between the base station BS1 and the mobile station MS then takes place on the basis of these capabilities and/or requirements by using a first radio technology RAT1, as considered below.

During the communication between the mobile station MS and the base station BS1, a base station which is adjacent to the base station BS1 and which is subsequently referred to as a candidate base station is sent information about the capabilities and/or requirements of the mobile station MS in respect of radio technologies. This may be the full information which is available to the base station BS1 on the basis of the notification by the mobile station MS, or just some of this information. This information can be transmitted directly from the base station BS1 to the candidate base station if the base stations are connected to one another. Alternatively, this transmission can also be effected by the device BS-MAN, to which the base station BS1 sends the information received from the mobile station MS and which forwards this information to the candidate base station. The criteria ascertaining the candidate base station from all the base stations which are adjacent to the base station BS1 are explained further below. It is subsequently assumed that the candidate base station is the base station BS2. This currently communicates using the radio technology RAT2, i.e. it currently does not use the radio technology RAT1. The radio technologies RAT1 and RAT2 may be based on the same radio standard but may differ in terms of the frequency range which is to be used for them. Examples of different frequency ranges are the ranges around 1.25 MHz, 3.5 MHz and 7 MHz. In this case, the frequency widths which are available for the different frequency ranges may also differ from one another. Alternatively, the radio technologies RAT1 and RAT2 may be different radio standards, such as GSM and UMTS, or WiMAX and 3G LTE.

The candidate base station reacts to the received information about the mobile station MS in order to be able to communicate with the mobile station MS. The base station BS2 is what is known as a multistandard base station (MSBS) which can perform a reconfiguration, so that it can use the radio technology RAT1 instead of or in addition to the radio technology RAT2. The nature of this reconfiguration is dependent firstly on the information received relating to the mobile station MS and secondly on the current state of the candidate base station.

Examples of possible reconfigurations are:
Obtaining or loading software which the candidate base station requires in order to use the radio technology RAT1. In this case, the software is preferably downloaded from a server which is set up for this purpose in the mobile radio network and which, by way of example, may be part of the O&M (Operation and Maintenance) system. It is also possible for the candidate base station to obtain the required software from the base station BS1, which is currently employing it for communication with the mobile station MS.
Reactivating a piece of software which is stored by the candidate base station but is currently not being used and which the candidate base station requires in order to use the radio technology RAT1.
Obtaining or loading a license for use of software which the candidate base station requires in order to use the radio technology RAT1. In this case, the software is preferably downloaded from a server which is set up for this purpose in the mobile radio network and which, by way of example, may be part of the O&M (operation and maintenance) system.
Measures for reserving radio resources for the radio technology RAT1. If the radio technology RAT1 requires the base station BS2 to use radio resources which the base station BS2 is currently not using for the radio technology RAT2, it is possible to make an agreement with adjacent base stations about respectively used radio resources, for example, in order to avoid intercell interference. If, by contrast, the radio technology RAT1 requires the base station BS2 to use radio resources which the base station BS2 is currently also using, at least in part, for the radio technology RAT2 then it is advantageous to reallocate radio resources to subscriber stations which are currently using the radio resources which are required for the radio technology RAT1, so that at least some of the radio resources for the radio technology RAT1 are not in use.

Following the reconfiguration, tests for plausibility and correct operation of the hardware can be carried out, so that errors when using the radio technology RAT1 are avoided. It is also advantageous if, prior to using the radio technology RAT1, the candidate base station uses a request to a central device, such as the device BS-MAN, to check whether use of the radio technology RAT1 could cause problems with other base stations.

If the candidate base station is provided with information relating to the transmission quality (quality of service) required by the mobile station MS in addition to the information about the radio technology, this information can be taken into account in the reconfiguration. This relates particularly to the scope or nature of the radio resources which the candidate base station is scheduling for the radio technology RAT1.

The reconfiguration takes place while the mobile station MS is communicating with the base station BS1, without any handover to the base station BS2 already having been initiated. The candidate base station can inform the base station BS1 that the reconfiguration has concluded and that communication is therefore possible between the candidate base station and the mobile station MS. To prevent the mobile station MS from changing from the radio technology RAT1 to a different radio technology when the candidate base station has been reconfigured, which means that the reconfiguration would not have been necessary, the mobile station MS can be sent a signaling message from the base station BS1 which prohibits it from changing the radio technology. This message can also indicate to the mobile station MS that measurements do not need to be performed on another system (intersystem measurement), since the currently used system provides the radio technology RAT1.

This saves the mobile station MS complexity which would arise from intersystem measurements.

It is also possible for the candidate base station to inform the base station BS1 if it was not possible to perform a reconfiguration for the candidate base station. In that case, either a handover from the base station BS1 to the candidate base station is not carried out or it is carried out if the mobile station MS changes from the radio technology RAT1 to the radio technology RAT2.

At a later time, the mobile station MS leaves the radio cell of the base station BS1 and enters the radio cell of the base station BS2. A handover is performed between the base stations BS1 and BS2. Since the base station BS2 is the candidate base station, this has already performed a reconfiguration, which means that it can begin to communicate with the mobile station MS using the radio technology RAT1 without delay. This advantage of a lack of delay as a result of the reconfiguration can be attributed to the fact that the reconfiguration actually takes place while the mobile station MS is communicating with the base station BS1, and not at the earliest at a time at which the handover to the base station BS2 has already begun. If, by contrast, the reconfiguration were not to take place until the handover to the base station BS2 is required, this could result in a call being disconnected or at least in quality impairments, because the base station BS2 cannot use the radio technology RAT 1 during the reconfiguration. The time required for reconfiguring the base station BS2 is dependent on what operations need to be performed in the course of the reconfiguration.

If the mobile station MS leaves the radio cell of the candidate base station again and no other subscriber station wishes to communicate with the candidate base station using the radio technology RAT1, the reconfiguration can be reversed again. If the candidate base station has downloaded the software for using the radio technology RAT1, it is possible for this not to be erased again but rather to be stored at least for a particular period of time.

The suitable candidate base station can be ascertained from the base stations which are adjacent to the base station BS1 by the base station BS1 or by another device, such as the BS-MAN.

When ascertaining the candidate base station, it is advantageous if the direction of movement of the mobile station MS, symbolized by an arrow in FIG. 1, is known and used. This can be established using a plurality of location measurements. If the positions of the base stations BS2, BS3 and BS4 which are adjacent to the base station BS1 are also known, it is possible to decide which radio cell the mobile station MS enters or at least—on the basis of a particular time and a particular direction of movement of the subscriber station MS—will probably enter after leaving the radio cell of the base station BS1.

In addition or as an alternative to the direction of movement of the mobile station MS, it is possible to use statistical data about the probability of subscriber stations entering a particular adjacent radio cell after leaving the radio cell of the base station BS1, possibly taking account of a particular location of the respective subscriber station in the radio cell of the base station BS1. If location measurements are used to establish that a subscriber station is moving in a particular direction on a road, for example, the radio cell which it enters after leaving the radio cell of the base station BS1 can be predicted with a high level of probability.

When selecting a suitable candidate base station, it is possible to take account of the capabilities and/or current parameters of the base stations. For this, it is advantageous if the base stations interchange current information relating to them, such as about their current utilization level, with one another or forward it to a central device. The utilization level is preferably measured on the basis of what volume of radio resources is currently in use in relation to the total radio resources available to the respective base station. A base station should then not be selected as a candidate base station if it currently has a high utilization level, which means that communication with another subscriber station would be unfavorable. In addition, it is possible to take account of the suitability of a base station for communication using the radio technology RAT1 desired by the mobile station MS. By way of example, this allows preference to be given to a base station if the reconfiguration is easy to perform for it, e.g. because it already has the necessary software available which merely needs to be activated, or because the relevant base station is currently using a radio technology and would merely need to change to a different frequency range. Including capabilities and/or current situations of the base stations in the ascertainment of the candidate base station is advantageous particularly when a plurality of base stations are suitable as potential handover destinations on the basis of the location or the direction of movement of the mobile station MS.

It is also possible to take account of parameters of the mobile station MS for ascertaining the candidate base station, regardless of the radio technology which the mobile station requires. By way of example, if a microcell and a macro-cell containing it are available, it is advantageous to select the microcell as the candidate base station for slowly moving subscriber stations and to select the macro-cell as the candidate base station for quickly moving subscriber stations.

It is possible that a plurality of candidate base stations are determined and accordingly the information relating to the mobile station MS is sent to a plurality of candidate base stations. This has the advantage that the mobility of the mobile station MS is taken into account, because the mobile station could quickly change direction to enter the radio cell of a base station which does not correspond to the most probable candidate base station. However, a drawback in this case is that firstly more transmission resources need to be used up as a result of the transmission of the information relating to the mobile station MS and secondly base stations may perform a complex reconfiguration without subsequently being able to use the radio technology which has just been set up.

To prevent a handover from being performed to a base station which cannot currently communicate using the radio technology RAT1 and has also not acquired this suitability by a reconfiguration, the list of adjacent cells which is transmitted by the base station BS1 can be adapted. This adaptation is carried out such that the list of adjacent cells exclusively indicates cells in which communication using the radio technology RAT1 is currently possible.

The time at which the information initiating the reconfiguration is sent to the candidate base station can be determined on the basis of various criteria. It is thus possible to send the information when the base station BS1 has collected a sufficient amount of information relating to the mobile station MS. In addition, the information can be sent when the subscriber station is in a particular proximity to the candidate base station, or when a particular probability of the subscriber station entering the radio cell of the candidate base station has been ascertained.

The method described in relation to the individual mobile station MS can be carried out for a plurality of or all subscriber stations. This is found to be particularly advantageous when a group of subscriber stations enters a new radio cell approximately at the same time. This is because this allows the reconfiguration to take account of the fact that a plurality of subscriber stations wish to use the radio technology which is not currently being used by the respective base station, which means that a reconfiguration should take place with a higher level of probability or to a greater extent.

The system also includes permanent or removable storage, such as magnetic and optical discs, RAM, ROM, etc. on which the process and data structures of the present invention can be stored and distributed. The processes can also be distributed via, for example, downloading over a network such as the Internet. The system can output the results to a display device, printer, readily accessible memory or another computer on a network.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-11. (canceled)

12. A method for operating a mobile radio communication system, comprising:
communicating by a first network radio station with a subscriber station using a first radio technology;
concurrently with said communicating by the first network radio station,
communicating by a second network radio station using a second radio technology,
receiving at the second network radio station information about radio technologies which can be used by the subscriber station,
performing a reconfiguration of the second network radio station to use the first radio technology,
communicating by the second network radio station, after the reconfiguration, with the subscriber station using the first radio technology.

13. The method as claimed in claim 12, wherein the reconfiguration comprises at least one of:
downloading a piece of software required for use of the first radio technology;
activating a piece of software required for use of the first radio technology;
obtaining authorization to use the first radio technology; and
reserving radio resources which can be employed for use of the first radio technology.

14. The method as claimed in claim 13, wherein the first radio technology and the second radio technology are based on different frequency ranges of the same radio standard, or on different radio standards.

15. The method as claimed in claim 14, wherein the second network radio station is selected from a plurality of network radio stations using information relating to at least one of
a location of the subscriber station;
movement of the subscriber station;
traffic routes in a radio coverage area of the first network radio station;
information about the radio technologies which can be used by the subscriber station;
usability of the first radio technology by the second network radio station; and
current utilization level of the second network radio station.

16. The method as claimed in claim 15, wherein the reconfiguration takes place prior to beginning of handover of the subscriber station from the first network radio station to the second network radio station.

17. The method as claimed in claim 16, wherein the second network radio station, during communication with the subscriber station using the first radio technology, communicates with at least one further subscriber station using the second radio technology.

18. The method as claimed in claim 17, further comprising, prior to said receiving by the second network radio station of the information about radio technologies which can be used by the subscriber station, sending the information about radio technologies from the subscriber station to the first network radio station.

19. The method as claimed in claim 18, further comprising sending information about the reconfiguration by the second network radio station.

20. The method as claimed in claim 19, further comprising sending, from the first network radio station to the subscriber station, a message prohibiting the change of radio technologies.

21. The method as claimed in claim 20, further comprising:
receiving, by additional network radio stations, the information about radio technologies which can be used by the subscriber station; and
performing a reconfiguration of the additional radio stations to use the first radio technology.

22. A mobile radio communication system, comprising:
at least one subscriber station;
a first network radio station including means for communicating with the subscriber station using a first radio technology;
means for sending information about radio technologies which can be used by said subscriber station, while said first network radio station is communicating with said subscriber station using the first radio technology; and
a second network radio station including
means for communicating using a second radio technology while said first network radio station is communicating with said subscriber station using the first radio technology,
means for receiving the information about radio technologies which can be used by said subscriber station,
means for performing a reconfiguration to use the first radio technology, while said first network radio station is communicating with said subscriber station using the first radio technology, and
means for communicating with said subscriber station using the first radio technology after the reconfiguration is performed.
